(19) United States
(12) Patent Application Publication
(10) Pub. No.: US 2009/0235344 A1
(43) Pub. Date: Sep. 17, 2009

(54) INFORMATION PROCESSING APPARATUS, INFORMATION PROCESSING METHOD, AND INFORMATION PROCESSING PROGRAM PRODUCT

(76) Inventors: Hiroki Ohzaki, Kanagawa (JP); Yuuichiroh Hayashi, Saitama (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/359,572

(22) Filed: Jan. 26, 2009

(30) Foreign Application Priority Data
Mar. 17, 2008 (JP) 2008-067482

(51) Int. Cl. H04L 9/32; G06F 15/16

(52) U.S. Cl. 726/7; 709/202

(57) ABSTRACT

In an information processing apparatus that includes a master agent and a subagent for SNMP and performs communication between the master agent and the subagent using an AgentX packet conforming to a standard stipulated by AgentX protocol, an authenticating unit determines whether a manager is legitimate based on authentication data included in the data acquisition request received from the manager by an authentication-data acquiring unit; a session-data creating unit creates session data including at least a result of authentication; a session-data providing unit provides to the subagent the session data; and an access control unit performs access control for data requested in the data acquisition request based on the session data received by the subagent.

### CROSS-REFERENCE TO RELATED APPLICATIONS

The present application claims priority to and incorporates by reference the entire contents of Japanese priority document 2008-067482 filed in Japan on Mar. 17, 2008.

### BACKGROUND OF THE INVENTION

1. Field of the Invention

The present invention relates to an information processing apparatus, an information processing method, and an information processing program product.

2. Description of the Related Art

In recent years, communication devices that provide various services to information processing apparatuses such as personal computers connected to a network by communicating with the information processing apparatuses have come to be used extensively. An example of such a communication device is an image forming apparatus such as a printer, a copier, a facsimile machine, a scanner, and a multifunction peripheral (MFP). An MFP is an image forming apparatus in which a single unit performs multiple tasks of printing, copying, facsimile, and scanning.

In the information processing apparatus that uses the services of the communication device, applications usually monitor the process status of the service being used, and control various processes according to the process status. Simple Network Management Protocol (SNMP) is an extensively used method for monitoring the process status and is a protocol for monitoring and controlling the processes via the network.

There are two software constituents in SNMP, namely an SNMP agent and an SNMP manager. The SNMP agent manages management information base (MIB) of managed devices, and makes data available according to the request made by the SNMP manager.

Agent extensibility (AgentX) protocol defines a standardized framework for extensible SNMP agents and is standardized in Request For Comments (RFC) 2741. RFC 2741 defines two types of agents called master agents and subagents. AgentX protocol is used for communication between the master agents and the subagents. Several technologies employing the AgentX protocol have been proposed. For example, a technology is disclosed in Japanese Patent Application Laid-open No. 2002-014883 for enhancing convenience in communication using AgentX by placing a proxy agent between the master agents and the subagents.

In AgentX protocol, the master agent collectively performs access control based on user data and a community name. In this case, the master agent allows access even for data that is not managed by the master agent itself. The access control is preferably performed by the subagent managing the concerned data. However, the subagent cannot determine which user is accessing the data, and therefore cannot provide data customized to the user. No solution can be provided for the problem because the access control has not been taken into consideration in the technology described above.

### SUMMARY OF THE INVENTION

It is an object of the present invention to at least partially solve the problems in the conventional technology.

According to an aspect of the present invention, there is provided an information processing apparatus that includes a master agent and a subagent for simple network management protocol, and performs communication between the master agent and the subagent using an AgentX packet that conforms to a standard stipulated by AgentX protocol, the information processing apparatus including an authentication-data acquiring unit that acquires, for every data acquisition request for acquiring data received from a manager, authentication data included in the data acquisition request; an authenticating unit that determines whether the manager is legitimate based on the authentication data; a session-data creating unit that creates session data that includes at least a result of authentication by the authenticating unit; a session-data providing unit that provides to the subagent the session data; and an access control unit that performs access control for the data requested in the data acquisition request based on the session data received by the subagent.

According to another aspect of the present invention, there is provided an information processing method configured to be executed in an information processing apparatus that includes a master agent and a subagent for simple network management protocol, and performs communication between the master agent and the subagent using an AgentX packet that conforms to a standard stipulated by AgentX protocol, the information processing method including acquiring, for every data acquisition request for acquiring data received from a manager, authentication data included in the data acquisition request; determining whether the manager is legitimate based on the authentication data; creating session data that includes at least a result of authentication at the determining; providing to the subagent the session data; and performing access control for the data requested in the data acquisition request based on the session data received by the subagent.

According to still another aspect of the present invention, there is provided an information processing program product that includes a computer program stored on a computer-readable recording medium which when executed on a computer that includes a master agent and a subagent for simple network management protocol and performs communication between the master agent and the subagent using an AgentX packet that conforms to a standard stipulated by AgentX protocol, causes the computer to execute the above information processing method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a device management system according to an embodiment of the present invention;

FIG. 2 is a block diagram of an example of a hardware configuration of a management target device shown in FIG. 1;

FIG. 3 is a block diagram of a functional configuration of the management target device;

FIG. 4 is a sequence diagram of a status-data providing process performed by each functional unit of the managed device shown in FIG. 3;

FIG. 5 is a configuration of an AgentX packet; and

FIG. 6 is a flowchart of an access control process performed by a data managing unit shown in FIG. 3.

### DETAILED DESCRIPTION OF THE PREFERRED EMBODIMENTS

Exemplary embodiments according to the present invention are explained below with reference to the accompanying drawings.

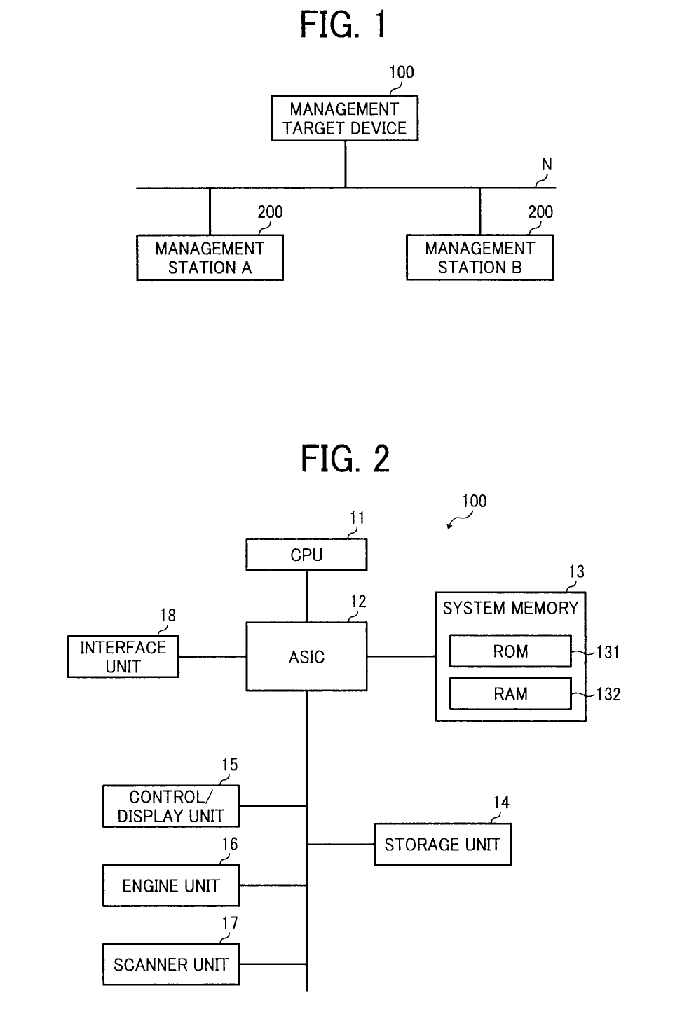

FIG. 1 is a block diagram of a device management system according to an embodiment of the present invention. The device management system includes a management target device 100 and management stations 200 (200A and 200B) that manage the management target device 100. The management target device 100 and the management stations 200A and 200B are connected to a network N and communicate with one another over the network N. The numbers of the management target device 100 and the management stations 200A and 200B connected to the network N are not limited to those shown in FIG. 1.

The management target device 100 can be a personal computer (PC), an image forming apparatus such as a copier or a printer, or an MFP that combines a printing function, an image reading (scanning) function, and the like, and is a device that is managed by the device management system according to the present embodiment.

FIG. 2 is a block diagram of an example of a hardware configuration of the management target device 100. The management target device 100 shown in FIG. 2 is assumed to be an MFP. The management target device 100 includes a central processing unit (CPU) 11, an application-specific integrated circuit (ASIC) 12, a system memory 13, a storage unit 14, a control/display unit 15, an engine unit 16, a scanner unit 17, and an interface unit 18.

The CPU 11 performs various processes by collaborating with various control programs stored in a read-only memory (ROM) 131 or the storage unit 14 and performs overall control of the management target device 100. When executing the control programs, the CPU 11 uses predetermined areas of a random access memory (RAM) 132 of the system memory 13 as working areas.

The CPU 11 further realizes various functional units explained later (a master agent 21, an authentication managing unit 22, an authenticating unit 23, subagents 24, and data managing units 25) by collaborating with designated computer programs stored in the ROM 131 or the storage unit 14 in advance.

The ASIC 12 is an integrated circuit (IC) that is specific for image processing and includes hardware components for image processing. The ASIC 12 functions as a bridge connecting each component of the management target device 100 with the CPU 11.

The system memory 13 is used as a storage memory for storing therein computer programs and data, a reading memory into which the computer programs and the data can be read, a drawing memory for the printer, or the like, and includes the ROM 131 and the RAM 132. The ROM 131 stores therein the computer programs and data and is a read-only memory. The RAM 132 is a writable and readable volatile memory used as a read memory for reading the computer programs and the data, a drawing memory for the printer, or the like.

The storage unit 14 includes a recordable storage medium that allows magnetic or optical recording. The storage unit 14 stores therein in a rewritable form the computer programs and various setting data required for the control of the management target device 100. The storage unit 14 also stores therein image data input via the scanner unit 17 and the interface unit 18.

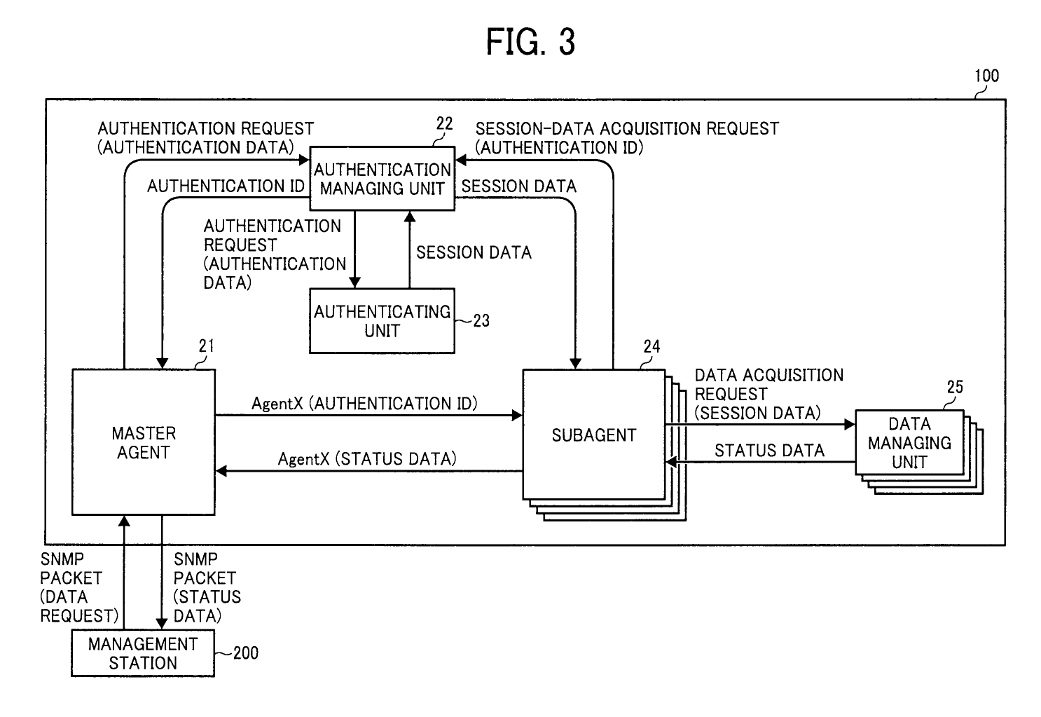

All of or part of the settings related to SNMP, such as a community name, a security level, and user data that are set in the regular management station 200 (manager), are stored in advance as collation data to be collated with authentication data in the storage unit 14. User data refers to information inherent in a user such as a user name or a language (selected language) of the user operating the management station 200. The collation data is used by the authenticating unit 23 (see FIG. 3) for authentication.

The control/display unit 15 functions as an interface between the management target device 100 and the user, and includes a display device such a liquid crystal display (LCD) and an input device such as key switches. The control/display unit 15, controlled by the CPU 11, displays the status and the operating method of the management target device 100 on the LCD, and detects and outputs to the CPU 11 any input that the user makes via a touch panel or the key switch group.

The engine unit 16 is a printer engine and can be a black-and-white plotter, a single-drum color plotter, a four-drum color plotter, a scanner, or a fax unit. In addition to the plotter that is so-called engine unit, the engine unit 16 includes an image processing unit such as for error diffusion and gamma conversion.

The scanner unit 17 includes a line sensor that is composed of charge-coupled device (CCD) optical converting elements, an analog-to-digital (A/D) converter, and their driving circuits. The scanner unit 17 scans an original, creates a digital image data based on the density information of the original, and outputs the digital image data to the CPU 11.

The interface unit 18 functions as an interface between the management target device 100 and an external device. Specifically, the interface unit 18 is a network interface that can connect to the network N and control transmission/reception of data between the management target device 100 and the management station 200 via the network N.

The management station 200 is an information processing device, such as a PC or a server, that manages the management target device 100. Although not shown, the management station 200 is configured like a computer and includes a CPU, a ROM, a RAM, and a hard disk drive (HDD), and functions as an SNMP manager due to the collaboration between the CPU and the computer programs stored in advance in the ROM or the HDD. The setting data (such as a community name, a security level, and user data) of the manager are stored in advance in a storage device (not shown), and the manager sends an SNMP packet that includes the setting data to the management target device 100.

The configuration of each functional unit realized by the collaboration between the CPU 11 and the computer program stored in the ROM 131 or the storage unit 14 is explained next with reference to FIG. 3.

FIG. 3 is a block diagram of a functional configuration (software configuration) of the management target device 100. The management target device 100 includes the master agent 21, the authentication managing unit 22, the authenticating unit 23, the subagents 24, and the data managing units 25. The master agent 21 and the subagents 24 conform to the standards stipulated by Request For Comments (RFC) 2741, and include functions explained below. The master agent 21 and the subagents 24 communicate using AgentX protocol.

Upon receiving an SNMP packet requesting acquisition of status data such as Management Information Base (MIB) from the management station 200 (manager), the master agent 21 acquires the setting data contained in the SNMP packet as authentication data. The SNMP packet from the management station 200 is hereinafter referred to as “SNMP packet (data request)”.

The authentication data refers to the setting data related to SNMP settings such as a community name, a security level, and user data set in advance between the SNMP manager and the master agent, and corresponds to the above collation data. Thus, in the present embodiment, because the settings related to SNMP that are set in advance between the manager and the master agent 21 are used as the authentication data, maintenance of data and data operations can be performed easily.

Upon acquiring the authentication data from the SNMP packet (data request), the master agent 21 outputs to the authentication managing unit 22 an authentication request for the authentication data. Upon receiving from the authentication managing unit 22 an authentication ID as a return value for the authentication request, the master agent 21 embeds the authentication ID in a transaction ID of an AgentX packet created for communication with the subagent 24, and outputs the AgentX packet to the subagent 24. A method of embedding the authentication ID in the AgentX packet is explained later.

Upon receiving status data from the subagent 24, the master agent 21 embeds the status data in a designated area in the SNMP packet, and sends the SNMP packet as an SNMP packet (status data) to the management station 200 from which the master agent 21 received the SNMP packet (data request).

The authentication managing unit 22 passes on the authentication request for the authentication data received from the master agent 21 to the authenticating unit 23. As a return value, the authenticating unit 23 sends session data to the authentication managing unit 22. Upon receiving the session data, the authentication managing unit 22 creates a unique authentication ID for the session data, and outputs the authentication ID to the master agent 21. The authentication managing unit 22 also temporarily stores the authentication ID and its corresponding session data in an associated manner in the RAM 132.

The format of the authentication ID created by the authentication managing unit 22 can be a numeric value assigned to each session data in ascending order or descending order. Because the authentication ID is to be embedded in the transaction ID of AgentX protocol in the present embodiment, the authentication ID should be four bytes or less.

Upon receiving an acquisition request of session data corresponding to a specific authentication ID from the subagent 24, the authentication managing unit 22 reads the session data corresponding to the authentication ID from the RAM 132, and outputs the acquired session data to the subagent 24 that placed the request.

Upon receiving the authentication request from the authentication managing unit 22, the authenticating unit 23 checks whether the information included in the authentication data for which authentication request is made and the information included in the collation data stored in advance in the storage unit 14 match, thereby determining whether the management station 200 (manager) that sent the authentication data is legitimate.

If the collation data and the authentication data match, the authenticating unit 23 creates session data that includes validity period of the session concerning the SNMP packet (data request) and authentication data, and outputs the session data to the authentication managing unit 22. If the collation data and the authentication data do not match, the authenticating unit 23 outputs an authentication failure notification as the session data to the authentication managing unit 22.

One subagent 24 is provided for every component (such as the engine unit 16 and the scanner unit 17) and computer program (process) that is to be monitored. Each subagent 24 outputs an acquisition request for the status data to the data managing unit 25 managed by the subagent 24 to acquire the status data of the MIB and the like, the status data indicating the status of the monitored object. The acquisition request for the status data output by the subagent 24 to the data managing unit 25 is hereinafter referred to as “data acquisition request”.

Specifically, upon receiving the AgentX packet from the master agent 21, the subagent 24 outputs to the authentication managing unit 22 an acquisition request of the session data corresponding to the authentication ID embedded in the transaction ID of the AgentX packet. The acquisition request of the session data made by the subagent 24 to the authentication managing unit 22 is hereinafter referred to as “session-data acquisition request”.

Upon receiving the session data from the authentication managing unit 22 as a return value for the session-data acquisition request, the subagent 24 outputs to the data managing unit 25 the data acquisition request including therein at least the session data. Upon receiving the status data from the data managing unit 25 as a return value for the data acquisition request, the subagent 24 embeds the status data in a designated area in the AgentX packet, and outputs the AgentX packet to the master agent 21.

The data managing unit 25 is associated with the subagent 24 managing the data managing unit 25, and is a functional unit that manages the status data of the MIB of the components or computer programs (processes) being monitored.

Upon receiving the acquisition request from the subagent 24, the data managing unit 25 outputs to the subagent 24 the status data of a monitoring target managed by itself.

When providing the status data, the data managing unit 25 performs access control based on the community name, the security level, and the user data in the session data included in the acquisition request. The access control refers to controlling browsing of status data and modifying the status data according to the community name, the security level, and the user data. The data managing unit 25 performs the access control based on access control data (not shown) stored in advance in the storage unit 14. The access control data is data in which the scope of browsable status data is defined according to the community name, the security level, and the user data.

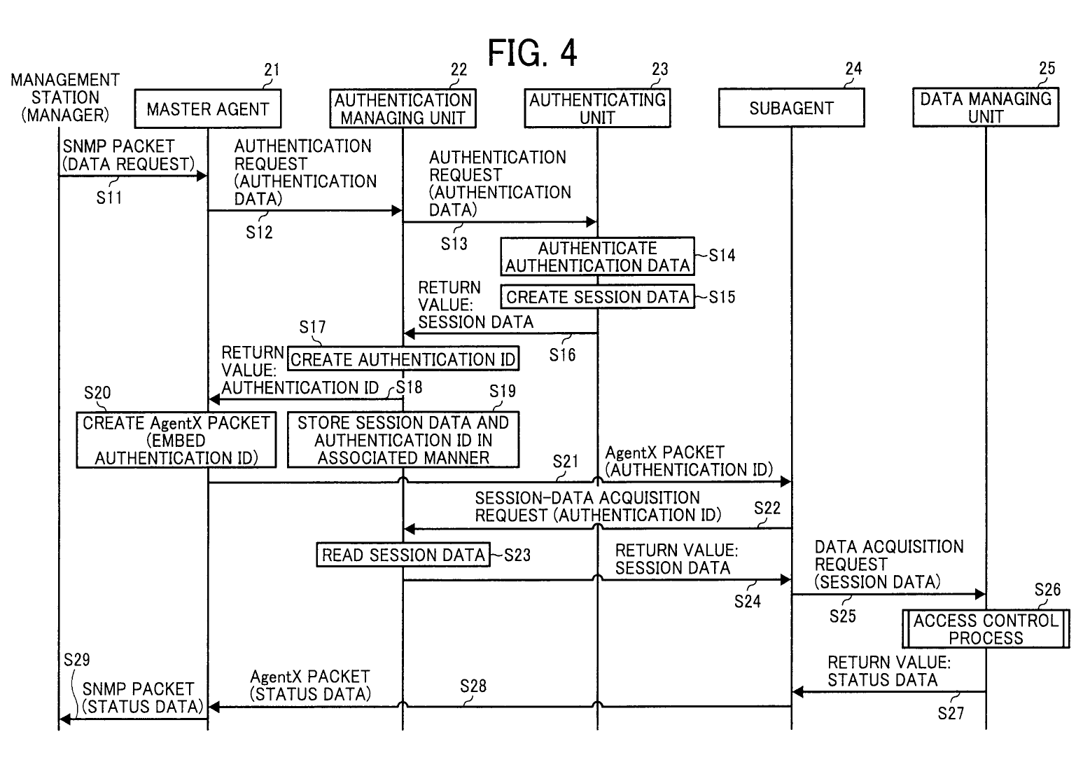

The functioning of the management target device 100 is explained below with reference to FIG. 4. FIG. 4 is a sequence diagram of a status-data providing process performed by the functional units of the management target device 100.

The master agent 21 receives the SNMP packet (data request) sent by the management station 200 (manager) (Step S11), and outputs to the authentication managing unit 22 data such as a community name, included in the SNMP packet (data request) as authentication data as an authentication request (Step S12).

The authentication managing unit 22 passes on the authentication request along with the authentication data to the authenticating unit 23 (Step S13). To authenticate the authentication data, the authenticating unit 23 collates the authentication data received from the authentication managing unit 22 with the collation data stored in the storage unit 14 (Step S14).

If the collation data and the authentication data match, the authenticating unit 23 creates the session data including therein the community name, the security level, and the user data included in the session (Step S15), and outputs the session data to the authentication managing unit 22 (Step S16).

Upon receiving the session data from the authenticating unit 23 as a return value for the authentication request, the authentication managing unit 22 creates a unique authentication ID for the session data (Step S17), and outputs the authentication ID to the master agent 21 (Step S18). The authentication managing unit 22 stores the authentication ID created at Step S17 and the session data received from the authenticating unit 23 in an associated manner in the RAM 132 (Step S19).

Upon receiving from the authentication managing unit 22 the authentication ID as a return value for the authentication request, the master agent 21 creates an AgentX packet to communicate with the subagent 24, and embeds the authentication ID in the transaction ID of the AgentX packet (Step S20).

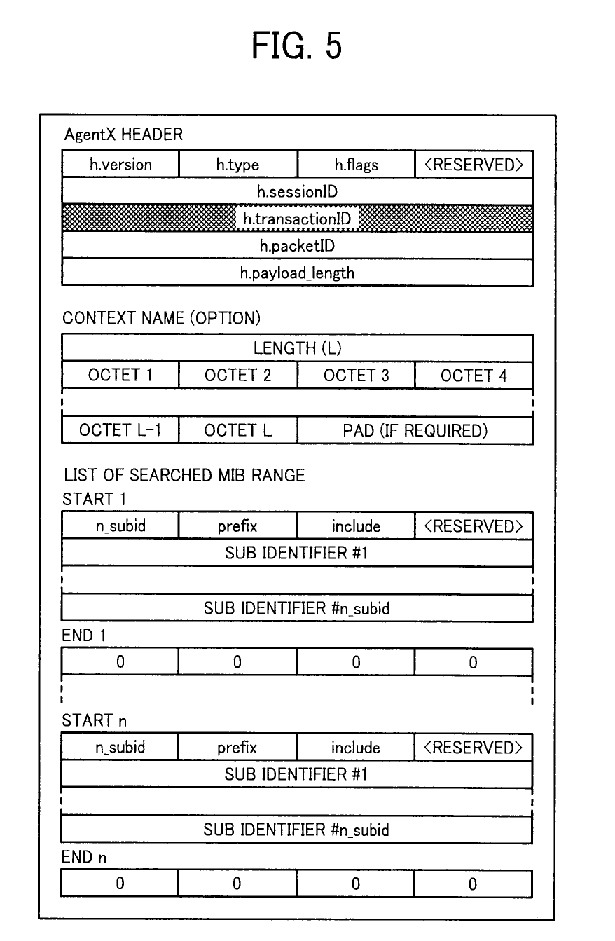

FIG. 5 is a schematic diagram of a configuration of an AgentX packet that conforms to the standards stipulated by RFC2741. Only an AgentX header of the AgentX packet is explained here, because the other elements are configured according to the standards stipulated by RFC2741.

The AgentX header is header data of the AgentX packet and includes various data pertaining to AgentX protocol. The AgentX header includes fields “h.version”, “h.type”, “h. flags”, “h.sessionID”, “h.transactionID”, “h.packetID”, and “h.payload_length”. The field “h.version” is an area for storing the version of AgentX protocol. The field “h.type” is an area for storing a protocol data unit (PDU). The field “h.flags” is an area for storing flag data. The field “h.sessionID” is an area for storing an ID for the session between the master agent 21 and the subagent 24. Session here refers to the session of AgentX communication and is different from the session data crated by the authenticating unit 23.

The field “h.transactionID” is an area for storing the transaction ID for differentiating MIB access in SNMP. The MIB access in SNMP represents a status that extends up to the time the master agent 21 acquires the status data from the subagent 24. In other words, the validity period of the transaction ID and the validity period the session data created by the authenticating unit 23 should match.

The focus of the present embodiment is in the matching of the validity period of the transaction ID and the validity period of the session data created by the authenticating unit 23, and embedding the unique authentication ID corresponding to the session data in the transaction ID, enables the subagent 24 to refer to the authentication data (session data). The field “h.transactionID” has a data length of four bytes, and the authentication managing unit 22 is configured to create a 4-byte authentication ID for every piece of session data.

The field “h.packetID” is an area for storing the packet ID for differentiating the PDUs between the master agent 21 and the subagent 24. The field “h.payload_length” is an area for storing the length of the PDU minus the common header.

The master agent 21 sends to the subagent 24 the AgentX packet with the authentication ID embedded therein (Step S21).

Upon receiving the AgentX packet from the master agent 21, the subagent 24 outputs to the authentication managing unit 22 a session-data acquisition request pertaining to the authentication ID embedded in the transaction ID of the AgentX packet (Step S22).

Upon receiving from the subagent 24 the session-data acquisition request corresponding to the authentication ID, the authentication managing unit 22 reads from the RAM 132 or the like the session data stored in association with the authentication ID (Step S23), and outputs the session data to the subagent 24 (Step S24).

Upon receiving from the authentication managing unit 22 the session data as a return value for the session-data acquisition request, the subagent 24 outputs to the data managing unit 25 a data acquisition request including therein at least the session data (Step S25).

Upon receiving the data acquisition request from the subagent 24, the data managing unit 25 performs the access control process based on the session data (Step S26).

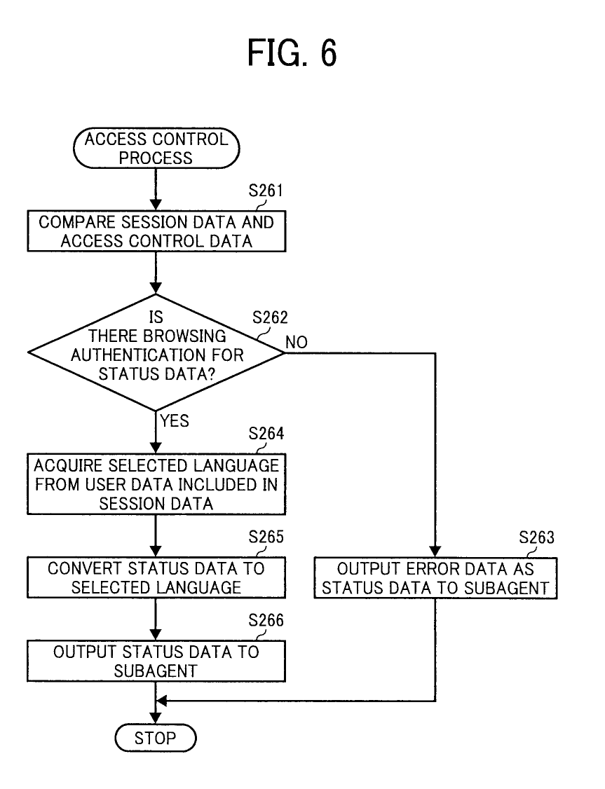

FIG. 6 is a flowchart of the access control process performed by the data managing unit 25. In the access control process, first, the data managing unit 25 compares data such as the community name included in the session data, and the access control data stored in advance in the storage unit 14 (Step S261), and determines whether there is browsing authentication for the status data (Step S262).

If the browsing authentication for the status data is absent (No at Step S262), the data managing unit 25 outputs to the subagent 24 error data indicating that browsing is not authenticated (Step S263), ending the process. For example, if the authenticating unit 23 determines that the authentication data and the collation data are not matching, the session data contains data indicating failed authentication. Consequently, at Step S262, the data managing unit 25 judges this as absence of the browsing authentication based on the session data.

If there is the browsing authentication for the status data (Yes at Step S262), the data managing unit 25 acquires the selected language from the user data in the session data (Step S264).

The data managing unit 25 converts the status data managed by itself to the selected language acquired at Step S264 (Step S265), and outputs the status data to the subagent 24 (Step S266), thus ending the process.

Thus, the session data output by the subagent 24 to the data managing unit 25 enables identification of the management station 200 or the user accessing the data. Consequently, browsing authentication can be granted or not granted, and if browsing authentication is granted, the content of the status data can be modified to suit the management station, such as the management stations 200A and 200B shown in FIG. 1, and the user operating the management station 200.

In the present embodiment, the status data is converted according to the selected language. The content of the status data can be restricted or modified according to other data included in the session data (such as a community name and a security level).

Once the status data is output to the subagent 24 by the access control process at Step S26 (Step S27), the subagent 24 receives the status data as a return value for the data acquisition request, sets the status data in the AgentX packet, and outputs the AgentX packet to the master agent 21 (Step S28).

Upon receiving the status data from the subagent 24, the master agent 21 sets the status data in the SNMP packet, and sends the SNMP packet as an SNMP packet (status data) to the management station 200 that sent the SNMP packet (data request) (Step S29).

Thus, according to the present embodiment, session data that includes at least the authentication data and its authentication result is created for every data acquisition request from the management station 200 (manager), and the authentication ID managed in association with the session data is embedded in the transaction ID of the AgentX packet. In this manner, the authentication ID is notified to the subagent 24 through the AgentX packet. The subagent 24 acquires the session data from the authentication managing unit 22 based on the authentication ID. The data managing unit 25 performs access control based on the authentication result and the authentication data included in the session data.

Thus, the session data can be made available to the subagent 24 without having to modify the specifications of the AgentX packet, thus enabling the subagent 24 to perform access control. Furthermore, because each subagent 24 individually grants access authentication to the requested data (status data) and performs processes specific to the authentication data corresponding to the status data, maintenance of data and data operations can be performed easily, and a highly accurate access control can be performed.

The present invention is not limited to the specific embodiments described above, and the components can be modified and embodied in an implementation phase without departing from the scope of the present invention. Different embodiments can be configured by appropriate combination of components disclosed in the described embodiments. For example, an embodiment can be configured with some of the components removed. Alternatively, an embodiment can be configured by appropriate combination of components of different embodiments.

For example, a computer program that executes the processes performed by the management target device 100 can be stored in a computer connected to a network such as the Internet, and made available through download over the network. The computer program can be configured to be made available or be distributed over the network.

Alternatively, the computer program can be stored in a storage medium such as a ROM, and made available.

According to an aspect of the present invention, the session data can be made available to a subagent without having to modify the specifications of an AgentX packet, thus enabling the subagent to perform access control.

According to another aspect of the present invention, each subagent individually grants access authentication to requested data. Consequently, maintenance of data and data operations can be performed easily, and a highly accurate access control can be performed.

According to still another aspect of the present invention, each subagent individually performs processes specific to the authentication data corresponding to the requested data. Consequently, maintenance of data and data operations can be performed easily, and a highly accurate access control can be performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that includes a master agent and a subagent for simple network management protocol, and performs communication between the master agent and the subagent using an AgentX packet that conforms to a standard stipulated by AgentX protocol, the information processing apparatus comprising:
an authentication-data acquiring unit that acquires, for every data acquisition request for acquiring data received from a manager, authentication data included in the data acquisition request;
an authenticating unit that determines whether the manager is legitimate based on the authentication data;
a session-data creating unit that creates session data that includes at least a result of authentication by the authenticating unit;
a session-data providing unit that provides to the subagent the session data; and
an access control unit that performs access control for the data requested in the data acquisition request based on the session data received by the subagent.

2. The information processing apparatus according to claim 1, further comprising:
a managing unit that associates the session data with identification data that uniquely differentiates the session data;
a packet creating unit that attaches the identification data to a designated area of the AgentX packet and outputs the AgentX packet from the master agent to the subagent concerned with the data acquisition request; and
a session-data requesting unit that requests the session-data providing unit to provide the session data corresponding to the identification data based on the AgentX packet received by the subagent, wherein
the session-data providing unit provides, in response to a request to provide the session data from the session-data requesting unit, the session data to the subagent corresponding to the session-data requesting unit.

3. The information processing apparatus according to claim 2, wherein the packet creating unit embeds the identification data in an area containing a transaction identification data in a header of the AgentX packet.

4. The information processing apparatus according to claim 1, wherein the access control unit performs the access control based on the result of authentication included in the session data.

5. The information processing apparatus according to claim 1, wherein the access control unit performs a designated process on the data requested by the manager based on the authentication data included in the session data.

6. The information processing apparatus according to claim 1, wherein the authentication data includes at least one of a community name of the manager, a security level of the manager, and user data.

7. An information processing method configured to be executed in an information processing apparatus that includes a master agent and a subagent for simple network management protocol, and performs communication between the master agent and the subagent using an AgentX packet that conforms to a standard stipulated by AgentX protocol, the information processing method comprising:
acquiring, for every data acquisition request for acquiring data received from a manager, authentication data included in the data acquisition request;
determining whether the manager is legitimate based on the authentication data;
creating session data that includes at least a result of authentication at the determining;
providing to the subagent the session data; and
performing access control for the data requested in the data acquisition request based on the session data received by the subagent.

8. The information processing method according to claim 7, further comprising:
associating the session data with identification data that uniquely differentiates the session data;
attaching the identification data to a designated area of the AgentX packet and outputting the AgentX packet from the master agent to the subagent concerned with the data acquisition request; and
requesting, at the providing, to provide the session data corresponding to the identification data based on the AgentX packet received by the subagent, wherein
the providing includes providing, in response to a request to provide the session data at the requesting, the session data to the subagent.

9. The information processing method according to claim 8, wherein the creating includes embedding the identification data in an area containing a transaction identification data in a header of the AgentX packet.

10. A computer program product that includes a computer program stored on a computer-readable recording medium which when executed on a computer that includes a master agent and a subagent for simple network management protocol and performs communication between the master agent and the subagent using an AgentX packet that conforms to a standard stipulated by AgentX protocol, causes the computer to execute:
acquiring, for every data acquisition request for acquiring data received from a manager, authentication data included in the data acquisition request;
determining whether the manager is legitimate based on the authentication data;
creating session data that includes at least a result of authentication at the determining;
providing to the subagent the session data; and
performing access control for the data requested in the data acquisition request based on the session data received by the subagent.
